(19) United States
(12) Patent Application Publication
(10) Pub. No.: US 2026/0160574 A1
(43) Pub. Date: Jun. 11, 2026

(54) METHOD FOR PROVIDING AN AUGMENTED REALITY NAVIGATION DISPLAY IN A MOTOR VEHICLE

(71) Applicant: CARIAD SE, Wolfsburg (DE)

(72) Inventors: Sven-Eric MOLZAHN, Wolfsburg (DE); Tobias SCHNELL, Wolfsburg (DE)

(21) Appl. No.: 18/706,711

(22) PCT Filed: Oct. 25, 2022
(86) PCT No.: PCT/EP2022/079702

§ 371 Date: May 1, 2024

(30) Foreign Application Priority Data
Nov. 4, 2021 (DE) 10 2021 128 711.1

(51) Int. Cl. G01C 21/36

(52) U.S. Cl. CPC G01C 21/365; G01C 21/3641

(57) ABSTRACT

The disclosure relates to a method including: acquiring input data for a driving maneuver of a motor vehicle, the input data describing an input by a driver of the motor vehicle at a distance from a location of the driving maneuver, the input causing an augmented reality navigation display in the motor vehicle to be activated or deactivated and the input data including first driving maneuver data that describe the one driving maneuver; identifying a future driving maneuver of the motor vehicle and determining second driving maneuver data that describe the future driving maneuver; checking whether comparable input data is available for the future driving maneuver by comparing the first driving maneuver data with the second driving maneuver data; and if acquired input data is available for the future driving maneuver, providing the augmented reality navigation display for the future driving maneuver according to the comparable input data.

### BACKGROUND

### Technical Field

The disclosure relates to a method for providing an augmented reality navigation display in a motor vehicle. The disclosure further relates to a motor vehicle that is designed to carry out such a method.

### Description of the Related Art

Augmented Reality (AR) or extended reality is the term for a computer-aided extension of a perception of reality. Such a computer-aided extension can comprise a computer-generated and thus visual representation of additional information generated with the aid of a computer. For example, an image and/or video can be supplemented with a virtual object as computer-generated additional information, for example by inserting the virtual object into the image or video. For this purpose, the computer-generated additional information is represented, for example, by inserting it into the image and/or video and/or as an overlay on the image and/or video.

In connection with a motor vehicle, an AR representation may be provided in connection with a navigation display, that is, an AR navigation display may be provided in the motor vehicle.

The AR navigation display typically has a video representation of an environment of the motor vehicle, preferably a front area of the motor vehicle. The video representation can, for example, be overlaid with computer-generated arrows and/or a representation of the vehicle's own position, which is typically in the form of a circular symbol. For example, a distance indication describing a distance between a current position of the motor vehicle and a location of a driving maneuver can be displayed.

Alternatively or in addition, for example, the computer-generated additional information can be displayed directly in a head-up display of the motor vehicle, that is, for example, without image and/or video representation. The computer-generated additional information is then displayed, for example, over an actual road view of a driver of the motor vehicle, which he/she can see when looking through a windshield of the motor vehicle. In this case, the AR navigation display only comprises the computer-generated additional information.

US 10,788,332 B2 discloses a method in which a navigation display can be modified in a user-specific manner based on the driver's voice input, by way of which he/she can comment on the navigation display. This allows personal preferences regarding navigation instructions to be analyzed.

### BRIEF SUMMARY

Embodiments of the disclosure provide a solution by way of which an augmented reality navigation display may be provided in a motor vehicle in a particularly advantageous manner.

A first aspect of the disclosure relates to a method for providing an augmented reality (AR) navigation display in a motor vehicle. To provide the AR navigation display, the motor vehicle has, for example, a controller and an external camera, such as a front camera, a side camera and/or a rear camera. Camera data acquired by the external camera preferably describes at least a section of an environment of the motor vehicle. Preferably, at least a section of the environment adjacent to a front area of the motor vehicle is acquired by way of the external camera. The controller can generate at least one piece of computer-generated additional information for the acquired camera data and integrate it into the camera data in the form of a virtual object. The virtual object can be overlaid on the camera data and/or displayed on it. The virtual object is, for example, a symbol that preferably visually describes an upcoming and therefore future driving maneuver of the motor vehicle. For example, one or more arrows can be placed on a video display based on the camera data, which illustrate to a viewer, i.e., preferably a driver of the motor vehicle, that and at what location in the environment of the motor vehicle the driving maneuver should be carried out. Such a video display with the displayed at least one virtual object is referred to, for example, as an AR navigation display. In other words, the AR navigation display preferably comprises a representation of at least a section of the environment of the motor vehicle, into which at least one virtual object is integrated. Alternatively or in addition, the virtual object can be displayed without an underlying video display, for example by way of a head-up display, in which the driver can see the environment of the motor vehicle even through a windshield of the motor vehicle, so that the AR navigation display only has the virtual object.

The AR navigation display is typically only temporarily displayed on an indicator in the motor vehicle. The AR navigation display is preferably only displayed from a predetermined distance to a location of a next driving maneuver until this location is reached. Otherwise and possibly in addition to the AR navigation display, a map display is typically provided by way of the indicator in the motor vehicle. The map view is, for example, a top view of a map with the motor vehicle's own position and route drawn. The map display and the AR navigation display can be displayed simultaneously in respective sections of a display area of the indicator.

The disclosure is based on the knowledge that the AR navigation display is shown and hidden, i.e., activated and deactivated, typically at a fixed standard distance from the location of the driving maneuver to which the AR navigation display relates. The AR navigation display of this type is therefore not personalized. In addition, it is often independent of the upcoming driving maneuver, that is, for example, it is specified across the board for all driving maneuvers and is therefore independent of, for example, a driving maneuver-specific feature. For example, it may be provided that the AR navigation display in the motor vehicle is always activated at a distance of 50 meters before turning from a road the motor vehicle is currently traveling onto another road. This distance can be independent of whether the motor vehicle is turning, for example, from a single-lane main road onto a comparatively less busy side road or whether, for example, it is turning from a multi-lane main road onto another comparably busy multi-lane main road. However, it may be the case that the driver of the motor vehicle wishes for a specific driving maneuver and/or it generally seems sensible to provide earlier or later activation of the AR navigation display. For example, when making a turn from the multi-lane main road, it may be desirable and/or sensible to activate the AR navigation display earlier than in the case of the single-lane main road, so that a greater distance of 200 meters is specified for the former driving maneuver compared to the previously specified 50 meters. It may also be the case that, depending on the driving maneuver, the driver does not want the AR navigation display to be activated because, for example, he/she does not need it. The reason for this is that a need and/or necessity for the AR navigation display is often subjective and dependent on the driving maneuver itself. It therefore makes sense to optimize the provision of the AR navigation display by taking into account a user request from the driver of the motor vehicle. The method according to the disclosure includes acquiring input data for at least one driving maneuver of the motor vehicle. The input data describes a manual input by a driver of the motor vehicle by way of an input unit. The manual input was made at a distance from a location of the at least one driving maneuver. Input data comprises distance data describing the distance. The input activates or deactivates the AR navigation display in the vehicle. By way of the input, the AR navigation display is switched on or the AR navigation display that is already displayed is switched off. The input data therefore comprises the information as to whether and, if so, at what distance from the location of the driving maneuver the driver manually activated the AR navigation display in the motor vehicle.

The input unit is, for example, a button, a switch, a rotary push switch and/or a key. The input unit can alternatively or in addition be provided as an element on a touch-sensitive screen in the motor vehicle. The input unit is preferably associated with a navigation system of the motor vehicle. The input unit can be arranged in a spatial proximity to an indicator, that is to say a screen or display, in the motor vehicle. At least one piece of information from the navigation system, such as a map display, can be displayed on a display area of the indicator. Alternatively or in addition, the input unit can be arranged on a steering wheel of the motor vehicle.

The input data has first driving maneuver data that describes the at least one driving maneuver. The input data preferably comprises information about several driving maneuvers, so that it has respective first driving maneuver data for each of the driving maneuvers. The first driving maneuver data, for example, has information about whether the first driving maneuver is a branching, a turning off a road, a lane change, an entry, for example into a roundabout and/or into a parking lot, and/or a driving behavior at an intersection. Other possible driving maneuvers include, for example, overtaking, passing, reversing, turning, swerving, parking and/or pulling out of a parking space. Preferably, a driving maneuver within the meaning of the disclosure is a maneuver that requires at least one steering input from the driver, that is to say comprises the driver impacting the lateral guidance of the motor vehicle.

For example, over a period of several days, weeks, months and/or years, the input data for driving maneuvers carried out is always acquired and, for example, stored in a storage unit of the motor vehicle and/or the controller of the motor vehicle. The input data is preferably associated with a single driver. For each driver of the motor vehicle, personalized input data is preferably acquired and, for example, stored. The respective driver of the motor vehicle can, for example, first be recognized by, for example, recognizing a personalized key in the motor vehicle and/or carrying out an identity check using an interior camera of the motor vehicle. It can therefore first be checked which driver is currently driving the motor vehicle, so that the current driver can be associated with the acquired input data. Data is therefore available on how the driver activated or deactivated the AR navigation display in the motor vehicle in the past. The input data thus describes a driving maneuver-dependent request from the driver for the AR navigation display.

The manual activation of the AR navigation display can always take place when the driver is already informed, for example due to the map view, i.e., a map display with a drawn route, that a certain driving maneuver is pending, but he/she, for example, particularly early before reaching the location of the driving maneuver wants the AR navigation display to provide support and therefore activates it manually.

In a further method step, a future driving maneuver of the motor vehicle is determined by way of a navigation system. For example, a current driving route is archived in the navigation system, which guides the motor vehicle from a starting point to a destination. The future driving maneuver is preferably a next upcoming driving maneuver according to the driving route of the motor vehicle. The future driving maneuver is preferably turning, changing lanes and/or entering and/or exiting the roundabout.

Once the future driving maneuver has been determined, second driving maneuver data is determined which describes the future driving maneuver. There is therefore information about the future driving maneuver, which, for example, have information about what kind of driving maneuver it is. For example, the future driving maneuver can be turning off the current road on which the motor vehicle is traveling onto a side road branching off from it. In this case, the second driving maneuver data at least describes that it is a turning off a road that is currently being traveled.

A further method step comprises checking whether comparable input data is available for the determined future driving maneuver. For this purpose, the acquired first driving maneuver data is compared with the determined second driving maneuver data. In other words, it is checked whether first driving maneuver data is available that describes a driving maneuver that corresponds to the determined second driving maneuver, preferably within predetermined deviation limits. That is to say, it is checked whether similar driving maneuver data is provided. Starting from the second driving maneuver data, similar first driving maneuver data, which is included in the input data, is preferably searched for. If such first driving maneuver data is found, comparable input data is available for the determined future driving maneuver. For example, the driving maneuver data can comprise a value. For example, the value is fixed for a junction from a main road to a side road. Entering a roundabout or turning at an intersection is linked to other, different values. If, for example, the value of the first driving maneuver data matches the value of the second driving maneuver data, it can be concluded that these are two identical driving maneuvers. The driving maneuvers that are similar in terms of a type of driving maneuver are referred to as similar or comparable driving maneuvers. In this case the checking is positive. In other words, comparable input data is present if the input data identified as comparable comprises first driving maneuver data that describes a driving maneuver that will also be the future driving maneuver according to the second driving maneuver data, at least in terms of its type.

The comparison of the driving maneuver data preferably does not take into account the absolute position of the driving maneuvers. It is therefore not taken into account whether the driving maneuvers match in terms of their location and are therefore identical. This means that no attention is paid as to whether input data exists for exactly the same driving maneuver at the same location. The driving maneuver is therefore viewed in an abstract way. Here, preference is given to the driving maneuver as such, that is, for example, as an event of turning and/or entering the roundabout and/or changing lanes, that is to say the type of driving maneuver.

It may be provided that a tolerance range is specified within which the first driving maneuver data must match the second driving maneuver data so that the driving maneuver data is viewed as comparable driving maneuver data and thus comparable input data is available. For example, deviations between the compared driving maneuver data can be tolerated. The tolerance range can, for example, range from 0 percent deviation to 1 percent, 2 percent, 3 percent, 5 percent, 10 percent, 20 percent and/or 30 percent deviation between the driving maneuver data. Driving maneuver data is therefore comparable if it describes respective driving maneuvers that are so similar that it can be assumed that the driver wants for such future driving maneuver the AR navigation display to be activated or deactivated according to his/her past reaction to this driving maneuver. It is therefore assumed that the driver wants an AR navigation display for the future driving maneuver analogous to the acquired manual input, which he/she prefers according to the input data for such a driving maneuver.

If comparable acquired input data is available for the determined future driving maneuver, that is, if the checking was successful, the AR navigation display for the determined future driving maneuver is provided in accordance with the comparable input data. If there is acquired input data for a driving maneuver that corresponds to the future driving maneuver, the AR navigation display in the motor vehicle is activated or possibly not provided at the distance to the location of the future driving maneuver, as provided for by the input data determined when checking for the comparable first driving maneuver data. For example, if it was recognized according to the input data that the driver typically activates the AR navigation display manually before turning from a main road into a side road at a distance of 200 meters from the location of the turn, that is, before the location of the driving maneuver, now, if the future driving maneuver also involves turning from a main road into a side road, the AR navigation display is automatically activated 200 meters before the location of the driving maneuver. The method thus learns the driver's personalized preferences and can then dynamically carry out an activation or omission of the AR navigation display that is typically preferred and desired by the driver in the motor vehicle for the future driving maneuver. This enables provision of the AR navigation display in the motor vehicle in a particularly convenient and therefore improved manner.

If the input data has several different manual inputs for comparable second driving maneuver data, for example the most frequently acquired manual input or a most recently acquired manual input in terms of time can be selected and, if necessary, taken into account when providing the AR navigation display.

The disclosure also includes exemplary embodiments which result in additional advantages.

One exemplary embodiment provides that the driving maneuver data has complexity data. The complexity data describes the complexity of the respective driving maneuver. The respective first driving maneuver data has respective first complexity data. The second driving maneuver data has second complexity data. The respective complexity data is determined by applying a complexity determination criterion to the respective driving maneuver data. The complexity determination criterion has a procedure and/or an algorithm based on which the complexity data is determined. The complexity data preferably comprises at least one value that quantifies the complexity of the driving maneuver. The complexity determination criterion is used to evaluate how complex the respective driving maneuver is. The complexity data preferably depends on the type of driving maneuver. For example, the complexity data for turning from the main road into the side road can assume a smaller value than, for example, turning left at an intersection. For this example, it is assumed that when turning from the main road into the side road there is no lane to cross with a traffic flow that is approaching the motor vehicle, whereas when turning left at the intersection there is such a lane to cross, so that such a driving maneuver requires a higher degree of complexity than just turning.

The complexity data provides an advantageous measure by which the first driving maneuver data can be quantitatively compared with the second driving maneuver data. For example, a driving maneuver can be identified as comparable if the complexity data matches or matches within the tolerance range.

An additional exemplary embodiment provides that the complexity determination criterion takes into account at least one of the following pieces of information: a road class of a road on which the motor vehicle is traveling before, when and/or after performing the driving maneuver; a number of lanes of the road; and/or a follow-up maneuver. The road class can, for example, differentiate between a main road and differently classified secondary roads or side roads. These roads can, for example, differ from each other with regard to a typical traffic density of a traffic volume on the respective road. The road class can therefore take into account a degree of traffic on the respective road. The road class can, for example, distinguish between an expressway, a country road and/or a traffic-calmed road, for example in a residential area. The road class can also distinguish between an inner-city or urban road and a road outside of the city.

The complexity data can also describe to which road class the road belongs from which the motor vehicle is carrying out the driving maneuver. The complexity data can further take into account the complexity of the driving maneuver during the road class change, for example whether a lane change occurs while the driving maneuver is being carried out, for example at an expressway intersection or expressway triangle. The complexity data can describe which road of which road class the motor vehicle changed to at the end of the driving maneuver. For example, different complexity data can be determined when the motor vehicle leaves a multi-lane main road onto a side road compared to the driving maneuver in which the motor vehicle moves from the side road onto the multi-lane main road.

The number of lanes of the road also contributes to the level of complexity, i.e., is described by the complexity data. This assumption is based on the observation that, for example, turning into and/or entering a multi-lane road is often a more complex driving maneuver than, for example, changing roads, which only involves single-lane roads.

The follow-up maneuver is a further future driving maneuver following the future driving maneuver. Alternatively, the follow-up maneuver can be referred to as a follow-up driving maneuver. A distance limit can be specified, with the further future driving maneuver only being a follow-up maneuver if a distance between the location of the future driving maneuver and the location of the further future driving maneuver is less than or equal to the distance limit. The distance limit is, for example, 5 meters, 10 meters, 15 meters, 20 meters, 30 meters, 50 meters, 100 meters, 200 meters, 300 meters and/or 500 meters. Alternatively or in addition, the distance limit value can take any value between the distance limit values mentioned. The follow-up maneuver is particularly interesting in connection with a roundabout, for example. Here, for example, after entering a roundabout, leaving or exiting the roundabout can be viewed as a follow-up maneuver. In the case of several consecutive road changes, for example in urban areas, the follow-up maneuver can have an impact on the complexity of the future driving maneuver, since, for example, a follow-up maneuver-dependent integration in a lane and/or a lane change must be carried out during the future driving maneuver with regard to the follow-up maneuver.

The complexity data can therefore be used to precisely differentiate between different driving maneuvers, so that when comparing the first and second driving maneuver data, it can ultimately be determined in detail whether and, if so, how comparable the future driving maneuver is to one of the past driving maneuvers that have already been acquired and are available in the form of the input data.

In addition, in one exemplary embodiment it is provided that standard distance data is provided for the at least one driving maneuver and/or the future driving maneuver. The standard distance data describes a standard distance to the location of the respective driving maneuver, upon reaching which the AR navigation display is automatically activated. The standard distance data is therefore at least a default setting that is archived, for example, in the controller of the motor vehicle and/or the navigation system and is therefore stored, for example. In addition to the driving maneuver data the standard distance data can be taken into account with the complexity data when determining at what distance to the location of the driving maneuver is provided and whether the AR navigation display is provided at all. For example, the standard distance data can always be taken into account as a crucial factor when there is no input data for a comparable driving maneuver for the future driving maneuver. For example, additionally or alternatively, it can be checked whether standard distance data has already been provided for the future driving maneuver and/or a driving maneuver comparable to the future driving maneuver. This data may correspond to or deviate from the distance data according to the acquired input data. As a result, when checking whether comparable first and second driving maneuver data are available, information for providing the AR navigation display for the future driving maneuver can ultimately still be determined, even if no input data is currently available for such a driving maneuver. For example, the AR navigation display can then be activated at the location of the standard distance to the location of the driving maneuver, so that the default setting regarding the activation of the AR navigation display is automatically activated. This is particularly interesting in the event that there is no manually generated input data for the specific driving maneuver.

Overall, when providing the AR navigation display, the future driving maneuver can be taken into account based on the second driving maneuver data, the complexity of the future driving maneuver based on the corresponding complexity data, the standard distance to the location of the respective driving maneuver, upon reaching which the AR navigation display is automatically activated, based on the standard distance data, and/or the distance to the location of the driving maneuver at which the driver's manual input in the past takes place, based on the input data.

In addition, an exemplary embodiment provides that a first driver profile associated with a driver of the motor vehicle is determined and stored based on the acquired input data. All manual inputs already known from the driver with regard to the activation and/or deactivation of the AR navigation display are preferably stored in the first driver profile. The first driver profile can be stored, for example, in a storage unit of the controller of the motor vehicle. Particularly preferably, the first driver profile is transmitted to the external computing unit via a communication link between the motor vehicle and an external computing unit, so that it can be included, for example, in a driver profile database of the external computing unit. The first driver profile can be correlated with and/or integrated into a user profile of the driver of the motor vehicle. It is then possible, for example when changing vehicles, for the acquired input data for the driver to also be available in the other motor vehicle when accessing the user profile preferably stored in the external computing unit in the other motor vehicle. The method can therefore be configured to be vehicle-independent and therefore cross-vehicle. Furthermore, documentation of the typical manual entries, i.e., the acquired input data, over a longer period of time may be provided. The motor vehicle therefore does not have to be acquired during each trip when the AR navigation display is typically activated manually and when not, but can access the data stored in the first driver profile.

According to an additional exemplary embodiment, it is provided that a check is made as to whether a driver profile database has at least a second driver profile that is comparable to the first driver profile. The driver profile database can be stored in the motor vehicle itself, that is, for example, in the storage unit of the controller. For this purpose, the motor vehicle can receive corresponding data describing the second driver profiles, for example from the external computing unit. Alternatively or in addition, the driver profile database can be stored externally, that is, for example, archived in the external computing unit.

Checking whether a comparable second driver profile is present in the driver profile database can be carried out, for example, by the external computing unit at the request of the motor vehicle. For this purpose, the motor vehicle can transmit the first driver profile, which it has determined and preferably stored, to the external computing unit, so that the comparison step, that is, comparing the first driver profile with possible second driver profiles stored there, can be carried out there.

If the driver profile database has the comparable second driver profile, the AR navigation display for the determined future driving maneuver is carried out according to the input data associated with the second driver profile. For example, it is checked whether there is information in the driver profile database about another driver who has a similar or possibly even the same behavior with regard to the manual input to activate or deactivate the AR navigation display in his motor vehicle. If this is the case, the typical behavior of this comparable second driver can be used when providing the AR navigation display. For example, if the second driver profile has the information that the driver would like to receive an AR navigation display at a distance of 300 meters before a specific driving maneuver, this distance is also used to provide the AR navigation display in the motor vehicle, namely if the corresponding second driver profile is comparable to the first driver profile. This can result in learning and/or additional consideration of comparable other drivers. This is particularly interesting, for example, if the driver is new to driving the motor vehicle and therefore, for example, there is only a small amount of input data on the driver.

Particularly preferably, in one exemplary embodiment it is provided that it is only checked whether the driver profile database has at least a second driver profile that is comparable to the first driver profile if no comparable input data according to the first driver profile was determined for the determined future driving maneuver. This means that only if the previously described step of checking, in which the second driving maneuver data is compared with the first driving maneuver data, turns out to be negative, the comparison is carried out with the driver profile database and a check is made as to whether a second driver profile that is comparable to the first driver profile is available. This makes the process particularly convenient because the experience of comparable drivers can be used.

It can further be provided that if no second driver profile that is comparable to the first driver profile can be identified, the AR navigation display is activated according to the standard distance data.

In one exemplary embodiment, it may be provided that in order to identify whether the at least one second driver profile is comparable to the first driver profile, a Pearson correlation between the driver profiles is calculated and evaluated. Thus, a statistical correlation method can be used, which can be used to check whether the respective driver profiles correlate with one another and are therefore comparable or not. This means that the comparison of the driver profiles can be carried out in a particularly resource-saving manner.

Another aspect of the disclosure relates to a motor vehicle. The motor vehicle preferably has a controller which, for example, has a processor and can therefore be a computer. The motor vehicle with the controller is designed to carry out the method described above. The motor vehicle according to the disclosure is preferably configured as a motor vehicle, in particular as a passenger car or truck, or as a passenger bus or motorcycle.

The disclosure also includes the controller for the motor vehicle. The controller can have a data processing device or a processor unit that is set up to carry out an embodiment of the method according to the disclosure. For this purpose, the processor unit can have at least one microprocessor and/or at least one microcontroller and/or at least one FPGA (Field Programmable Gate Array) and/or at least one DSP (Digital Signal Processor). Furthermore, the processor unit can have program code that is designed to carry out the embodiment of the method according to the disclosure when executed by the processor unit. The program code can be stored in a data storage unit of the processor unit.

The disclosure also includes refinements of the motor vehicle according to the disclosure, which have features as have already been described in connection with the exemplary embodiments of the method according to the disclosure. For this reason, the corresponding refinements of the motor vehicle according to the disclosure are not described again here.

The disclosure also includes the combinations of the features of the exemplary embodiments described. The disclosure therefore also comprises realizations that each have a combination of the features of several of the exemplary embodiments described, provided that the exemplary embodiments have not been described as mutually exclusive.

### BRIEF DESCRIPTION OF THE SEVERAL VIEWS OF THE DRAWINGS

Exemplary embodiments of the disclosure are described below. In the figures:

FIG. 1 shows a schematic representation of a motor vehicle with an augmented reality navigation display; and

FIG. 2 shows a schematic representation of a signal flow graph of a method for providing an augmented reality navigation display in a motor vehicle.

### DETAILED DESCRIPTION

The exemplary embodiments explained below are advantageous embodiments of the disclosure. In the exemplary embodiments, each of the described components of the embodiments represents individual features of the disclosure that are to be considered independently of one another and which also refine the disclosure independently of one another. Therefore, the disclosure is intended to comprise combinations of the features of the embodiments other than those shown. Furthermore, the described embodiments can also be supplemented by further features of the disclosure that have already been described.

In the figures, same reference numerals designate functionally identical elements.

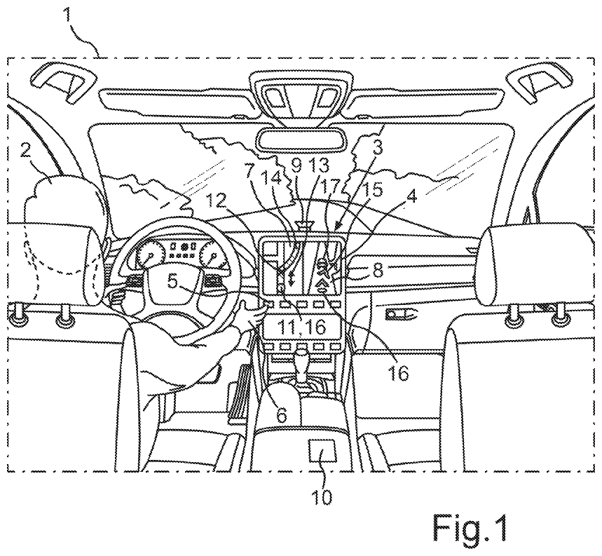

FIG. 1 shows a motor vehicle 1. There is a driver 2 in motor vehicle 1. Driver 2 is therefore a passenger and/or user of motor vehicle 1. Motor vehicle 1 has a navigation system 3. For example, in addition to navigation system 3, motor vehicle 1 has an indicator 4. Indicator 4 is, for example, a screen, in particular a touch-sensitive screen, and/or a display.

Motor vehicle 1 has an input unit 5. As an example, input unit 5 is designed here as a button in spatial proximity to indicator 4. Alternatively or in addition to arranging input unit 5 in the area of a center console of motor vehicle 1, it can be arranged, for example, on a steering wheel of the motor vehicle 1. Alternatively or in addition to the configuration as a button, input unit 5 can be a switch, a rotary push switch, a key and/or an element on the touch-sensitive screen as indicator 4. In a situation outlined in FIG. 1, driver 2 operates input unit 5 with one hand 6. This means, there is a manual input by driver 2 by way of input unit 5.

A map display 7 of navigation system 3 is provided on indicator 4. This is shown here as an example on a left half of indicator 4 in the direction of view of driver 2. Map display 7 is, for example, a top view of a map in which information from navigation system 3 is displayed. An augmented reality (AR) navigation display 8 is outlines on a right half of indicator 4 in the direction of view of driver 2. This has a perspective view of a road on which motor vehicle 1 is currently driving. The perspective representation is based on camera data that is acquired by a front camera 9 of motor vehicle 1. In addition, AR navigation display 8 has at least one piece of computer-generated additional information. This and the generation of entire AR navigation display 8 is preferably carried out by way of a controller 10 of motor vehicle 1.

Further information outlined here regarding navigation system 3 is, for example, an input location 11, a location 12, and a distance 13. The input location 11 is a position at which a manual input by driver 2 takes place using input unit 5. Input location 11 is located spatially before location 12 where a driving maneuver takes place. The driving maneuver in the example outlined here involves turning from a current road onto another road. Distance 13 between input location 11 and location 12 of the driving maneuver is shown with a double-headed arrow. The information of input location 11, location 12 and distance 13 are typically not visually displayed by way of map display 7 of navigation system 3 of motor vehicle 1 and are shown here purely to illustrate the method according to the disclosure.

Map display 7 also shows travel trajectory 14, which marks a driving route of motor vehicle 1 to a predetermined destination of motor vehicle 1 on the map.

In AR navigation display 8, a video representation of the environment of front camera 9 and thus a front area of motor vehicle 1 acquired by front camera 9 is overlaid with virtual objects, which are designed here as AR arrows 15. AR arrows 15 show a course of driving trajectory 14 for the driving maneuver, that is, they visually highlight the direction of the turn from the current road to the future road.

Alternatively or in addition, for example, the virtual object, such as one or more AR arrows 15, can be displayed directly in a head-up display (not shown here) of motor vehicle 1, that is, for example, without displaying the sensor data of front camera 9. The virtual object is then displayed, for example, over an actual road view of the road currently being traveled, which driver 2 of motor vehicle 1 can see when looking through a windshield of motor vehicle 1. In this case, AR navigation display 8 only comprises the computer-generated additional information.

In addition, an example of motor vehicle's 1 own position 16 is shown in the map display 7 and AR navigation display 8. The motor vehicle's 1 own position 16 corresponds to input location 11 in the example outlined. Furthermore, in AR navigation display 8 further vehicles 17 are shown, which are captured by front camera 9. In the example outlined here, this is another vehicle 17 that is driving in front of motor vehicle 1 in the direction of travel of motor vehicle 1.

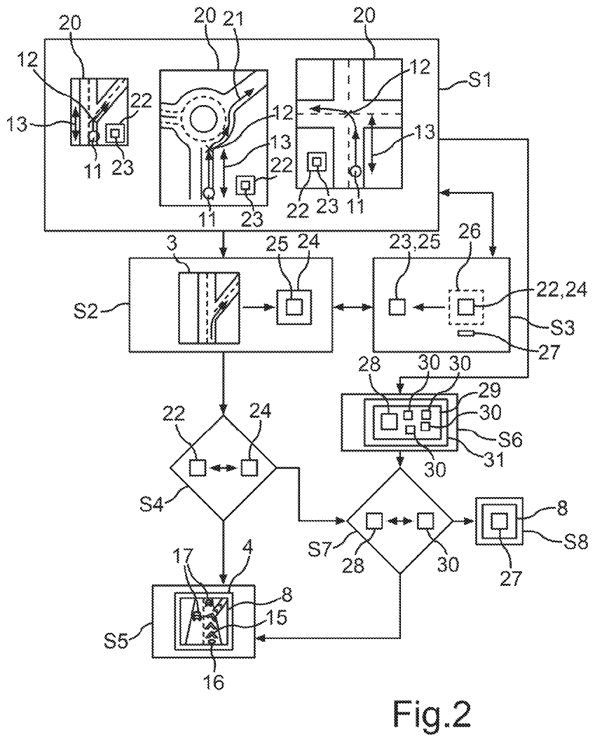

FIG. 2 shows the method for providing AR navigation display 8 in motor vehicle 1. A first method step S1 comprises acquiring input data 20. Here, input data 20 for three different driving maneuvers of motor vehicle 1 is shown as examples. These driving maneuvers were carried out in the past by driver 2 of motor vehicle 1. This input data 20 is stored, for example, in a storage unit of controller 10 in motor vehicle 1 and is therefore archived in motor vehicle 1, for example. Input data 20 here refers to three different driving maneuvers as an example. In the viewing direction of the viewer of FIG. 2 from left to right, on the left, turning from a current road traveled by motor vehicle 1 onto another road, for example classified as a side road, in the middle, entry into a two-lane roundabout, and, on the right, a left turn at an intersection. Regarding the driving maneuver shown in the middle, a follow-up maneuver 21 to this driving maneuver is outlined. According to follow-up maneuver 21, motor vehicle 1 can leave the roundabout, that is to say follow-up maneuver 21 involves exiting the roundabout. In addition to the three possible driving maneuvers mentioned here, which are comprised by input data 20, input data 20 for further possible driving maneuvers can be acquired. The three driving maneuvers described are purely exemplary in nature and are not intended to be exhaustive. Input data 20 for any number of identical and/or different driving maneuvers can be acquired and therefore available.

Input data 20 describes a manual input by driver 2 of motor vehicle 1 by way of input unit 5, which was made at a distance 13 from location 12 of the respective driving maneuver. AR navigation display 8 in motor vehicle 1 is activated by the manual input or if it had been already activated, for example, deactivated. For example, input data 20 comprises that in the case of the driving maneuver shown on the left, driver 2 has already manually activated AR navigation display 8 at a distance 13 of 300 meters before location 12 of the turn onto the side road. This indicates that in the case of such a driving maneuver, driver 2 could want information about the upcoming driving maneuver at an early stage and thus, for example, an early supplementation of map display 7 with AR navigation display 8 is desired. Alternatively, it can be captured by way of input data 20 that driver 2, for example in the driving maneuver outlined on the left, in the past has deactivated an AR navigation display 8 that was automatically activated 200 meters before reaching location 12 of the turn by way of the manual input. From this it can be concluded that when simply turning from a main road to a side road, for example, he/she does not want any support from AR navigation display 8.

Input data 20 has first driving maneuver data 22 that describes the respective driving maneuver. Driving maneuver data 22 also has first complexity data 23, which describes the complexity of the respective driving maneuver.

In a method step S2, a future driving maneuver of motor vehicle 1 is identified by way of navigation system 3. Second driving maneuver data 24 is also determined, which describe the future driving maneuver. Second driving maneuver data 24 preferably also has complexity data 25, which is referred to here as second complexity data 25. In the example outlined here, for example, it is identified that turning from the road currently driven by motor vehicle 1 onto a side road is a future driving maneuver.

Complexity data 23, 25 can be determined in a method step S3. For this purpose, a complexity determination criterion 26 is applied to respective driving maneuver data 22, 24, that is to say on first driving maneuver data 22 and on second driving maneuver data 24. Complexity determination criterion 26 is a procedure and/or an algorithm which takes into account at least one of the following pieces of information: A road class of the road on which the motor vehicle 1 is traveling before performing the driving maneuver, when performing the driving maneuver and/or after performing the driving maneuver; a number of lanes of the road; and/or the follow-up maneuver 21. In addition to complexity data 23, 25, standard distance data 27 can be taken into account. Standard distance data 27 can, for example, always be taken into account when no input data 20 is available for a specific driving maneuver. The standard distance data 27 describes a standard distance, upon reaching which, for example, according to a default setting in motor vehicle 1, AR navigation display 8 is automatically activated.

In a method step S4, a check is made as to whether comparable input data 20 is available for the determined future driving maneuver. For this purpose, acquired first driving maneuver data 22 is compared with determined second driving maneuver data 24. Ultimately, it is identified whether input data 20 contains information about a driving maneuver that corresponds to the future driving maneuver or at least matches it within a tolerance range. For this purpose, various driving maneuvers are evaluated, for example taking into account complexity data 23, 25, wherein, for example, for each of the three driving maneuvers mentioned in method step S1, differing first driving maneuver data 22 and first complexity data 23 or, if it is a future driving maneuver, differing second driving maneuver data 24 and second complexity data 25 are available. Ultimately, each driving maneuver is preferably assigned a value depending on its complexity, based on which the comparison can be carried out. If such a value from input data 20 matches the corresponding value of second driving maneuver data 24, at least one of the acquired driving maneuvers matches the future driving maneuver, i.e., is comparable.

In a method step S5, if acquired input data 20 is available for the determined future driving maneuver, AR navigation display 8 for the determined future driving maneuver is provided according to comparable input data 20. In the example outlined here, for example, by way of input data 20, which is associated with the driving maneuver shown on the left in method step S1, AR navigation display 8 is automatically activated in the motor vehicle at a distance 13 of 300 meters before location 12 of the turn from the main road into side road because driver 2 has previously wanted this for such a case according to previously acquired input data 20. The left driving maneuver is comparable here to the future driving maneuver from method step S2 mentioned as an example. Distance 13 between location 12 of activating AR navigation display 8 and actual location 12 of the future driving maneuver is therefore set as provided by input data 20 on the comparable driving maneuver. In the example mentioned here, distance 13 of 300 meters will also be selected. When the future driving maneuver occurs, AR navigation display 8 will be automatically activated at a distance 13 of 300 meters before location 12 of the turn.

However, if driver 2 did not want an AR navigation display 8 at all during a comparable driving maneuver according to input data 20, an AR navigation display 8 will not be activated in method step S5.

In a method step S6, a first driver profile 28 associated with driver 2 of motor vehicle 1 is determined and stored based on acquired input data 20. First driver profile 28 can be stored in the storage unit of controller 10. Alternatively or in addition, it can be archived in a driver profile database 29, in which at least one second driver profile 30 of another driver 2 is stored also. Driver profile database 29 with first driver profile 28 and the preferably several second driver profiles 30 can be stored in a computing unit 31 arranged outside motor vehicle 1 and thus archived there. In this case, a preferably wireless data exchange between motor vehicle 1 and computing unit 31 may be provided. For data exchange, there may be a communication link between motor vehicle 1 and computing unit 31, for example via a wireless local area network (WLAN), a Bluetooth connection and/or a mobile data network, for example based on the Long Term Evolution (LTE), Long Term Evolution Advanced (LTE-A), Fifth Generation (5G) or Sixth Generation (6G) mobile communications standard.

Individual driver profiles 28, 30 thus have acquired input data 20 on the manual inputs of a specific driver 2 for activating and/or deactivating AR navigation displays 8 as well as respective first driving maneuver data 22. It can therefore be known how both driver 2 of motor vehicle 1 and at least one other driver 2 of another vehicle 17 behave in different driving maneuver situations with regard to AR navigation display 8.

In a method step S7, for example, it is checked whether at least one second driver profile 30, which is comparable to first driver profile 28, is stored in driver profile database 29. If driver profile database 29 has comparable driver profile 30, AR navigation display 8 for the determined future driving maneuver can be according to input data 20 associated with second driver profile 30. For example, proceeding to method step S5, driver's own input data 20 for the comparable driving maneuver is not taken into account, but rather comparable input data 20 for the comparable driving maneuver taken from second driver profile 30.

Particularly preferably, method step S7 only takes place if it was identified during checking in method step S4, that no input data 20 previously acquired in motor vehicle 1, which were acquired in method step S1, are available for the determined future driving maneuver. In this case, it may be provided that, whenever method step S4 is positive, no comparison is carried out with driver profile database 29.

To identify whether the at least one second driver profile 30 is comparable to first driver profile 28, a Pearson correlation between driver profiles 28, 30 can be calculated and evaluated. Hence, typical methods of statistical evaluation can be used.

If it is identified that there is no second driver profile 30 that describes a driving maneuver that is comparable to the future driving maneuver, AR navigation display 8 can, for example, be provided according to standard distance data 27. That is to say, an already preset standard distance can be used to determine at which own position 16 and thus at what distance 13 from location 12 of the future driving maneuver AR navigation display 8 is activated or not activated.

Overall, the examples show a method for displaying a guidance instruction in AR navigation depending on the maneuver. AR navigation display 8 has previously been started during a driving maneuver, such as a right turn, at a fixed time before the driving maneuver and additional virtual information on the driving maneuver is displayed. Depending on the actual driving maneuver, distance 13 to location 12 where the driving maneuver is carried out is therefore specified. This is now improved by training a model that takes the manual input from driver 2 and suggests a personalized distance 13. In a first example, driver 2 can approach a driving maneuver and manually activate AR navigation display 8 in motor vehicle 1. One reason for this may be that he/she wants to activate AR navigation display 8 well in advance of the driving maneuver. An example of this is a complex roundabout for which driver 2 would like to prepare well in advance. In a further example, it may be provided, for example, that when simply turning right from a current road to a side road, driver 2 does not need an AR navigation display 8 at all, which is why he/she deactivates it manually, for example, in order not to be distracted from the current trip, for example. In this case, manual input may comprise, for example, deactivating AR navigation display 8.

The method provides a personalized distance 13 for each driving maneuver, depending on the type and complexity of the driving maneuver for which AR navigation display 8 is provided or not. The following information is taken into account as possible input vectors: the upcoming navigation maneuver, that is, second driving maneuver data 24, which describes the future driving maneuver; a complexity of the driving maneuver described by a change in a road class, that is, first and second complexity data 23, 25; a standard distance in meters for typically activating the driving maneuver, that is, standard distance data 27, which describes when AR navigation display 8 is typically activated automatically; and/or distance 13 in meters from the manual input of driver 2 to location 12 of the driving maneuver, that is, distance 13 between input location 11 and location 12.

The method calculates a preferred distance 13 for each type and category of navigation maneuver from the information mentioned and, for example, provides a difference or alternative to standard distance data 27.

It may be provided that suggestions beyond own preferences are made by way of a Pearson correlation. For this purpose, driver profile database 29 is searched for second driver profiles 30, taking into account first driver profile 28. According to the Pearson method, first driver profile 28 and second driver profiles 30 of driver profile database 29 are compared with one another and further suggestions are made for the driving maneuvers (unrated item prediction). The narrative could be similar to: “Users like you choose an AR navigation aid 200 meters in advance at a roundabout 80 percent of the time.” This could happen automatically in the background and the method could be improved globally, or it could be left to driver 2 upon request.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for providing an augmented reality navigation display in a motor vehicle, the method comprising:
acquiring input data for at least one driving maneuver of the motor vehicle, wherein the input data describe a manual input by a driver of the motor vehicle by way of input unit at a distance from a location of the at least one driving maneuver, the manual input causing the augmented reality navigation display in the motor vehicle to be activated or deactivated and the input data including first driving maneuver data that describe the at least one driving maneuver;
identifying a future driving maneuver of the motor vehicle by way of a navigation system;
determining second driving maneuver data that describes the future driving maneuver by way of the navigation system;
checking whether comparable input data is available for the future driving maneuver by comparing the first driving maneuver data with the second driving maneuver data; and
if acquired input data is available for the future driving maneuver, providing the augmented reality navigation display for the future driving maneuver according to the comparable input data.

2. The method according to claim 1, wherein the first driving maneuver data and the second driving maneuver data include complexity data that describe a complexity of the at least one driving maneuver and the complexity is determined by applying a complexity determination criterion to each of the at least one driving maneuver data.

3. The method according to claim 2, wherein the complexity determination criterion takes into account at least one:
a road class of a road on which the motor vehicle travels before, during and/or after performing the driving maneuver;
a number of lanes of the road; or
a follow-up maneuver.

4. The method according to claim 1, further comprising:
providing predefined standard distance data for the at least one driving maneuver and/or the future driving maneuver, wherein the predefined standard distance data describe a standard distance to the location of the at least one driving maneuver, upon reaching which the augmented reality navigation display is automatically activated; and
if no input data is available for the future driving maneuver, providing the augmented reality navigation display according to the predefined standard distance data.

5. The method according to claim 1, further comprising:
determining a first driver profile associated with a driver of the motor vehicle based on the acquired input data; and
storing the first driver profile.

6. The method according to claim 5, further comprising:
checking whether a driver profile database includes at least one second driver profile that is comparable to the first driver profile; and
if the driver profile database has the at least one second driver profile, providing, the augmented reality navigation display for the future driving maneuver takes according to the input data associated with the at least one second driver profile.

7. The method according to claim 6, wherein the checking includes checking whether the driver profile database includes the at least one second driver profile if comparable input data was not identified for the future driving maneuver.

8. The method according to claim 6, wherein, the checking whether the driver profile database includes the at least one second driver profile that is comparable to the first driver profile, includes calculating a Pearson correlation between the at least one second driver profile and the first driver profile and evaluating the Pearson correlation.

9. A motor vehicle, comprising:
a processor; and
a memory storing program code that, when executed by the processor, cause the motor vehicle to:
acquire input data for at least one driving maneuver of the motor vehicle, wherein the input data describe a manual input by a driver of the motor vehicle by way of input unit at a distance from a location of the at least one driving maneuver, the manual input causing an augmented reality navigation display in the motor vehicle to be activated or deactivated and the input data including first driving maneuver data that describe the at least one driving maneuver;
identify a future driving maneuver of the motor vehicle by way of a navigation system;
determine second driving maneuver data that describe the future driving maneuver by way of the navigation system;
check whether comparable input data is available for the future driving maneuver by comparing the first driving maneuver data with the second driving maneuver data; and
if acquired input data is available for the future driving maneuver, provide the augmented reality navigation display for the future driving maneuver according to the comparable input data.
